(19) United States
(12) Patent Application Publication
(10) Pub. No.: US 2008/0288610 A1
(43) Pub. Date: Nov. 20, 2008

(54) Image Control System and Method

(76) Inventor: Takeshi Isono, Tokyo (JP)

Correspondence Address: RATNERPRESTIA, P O BOX 980, VALLEY FORGE, PA, 19482-0980, US

(21) Appl. No.: 10/585,539

(22) PCT Filed: Mar. 10, 2004
(86) PCT No.: PCT/JP2004/003071

§ 371 Date: Jul. 10, 2006

(30) Foreign Application Priority Data
Jan. 9, 2004 (JP) 2004-003782

(51) Int. Cl. G06F 15/16

(52) U.S. Cl. 709/219

(57) ABSTRACT

An image control system for allowing a user to freely access a Web server of a carrier other than the carrier providing a portable telephone service utilized by the user. The image control system comprises a plurality of portable telephones 11 each having an image display function in a different display format, and a Web server 12 for forming an image information D in a display format which may be displayed on a display panel of the portable telephone 11 transmitting the request, and transmitting the image information D to each of portable telephone 11.

### TECHNICAL FIELD

The present invention generally relates to an image control system and method in a communication network, particularly to an image control system and method for displaying an image on an image display panel provided in a portable terminal connected to a communication network regardless of the difference of image formats.

### BACKGROUND ART

A portable telephone that a user can be interactively communicated with another portable telephone while moving as a portable terminal connected to a communication network is conventionally known. A telephone service using portable telephones is provided by telecommunication companies (i.e., carriers, there are now three carriers in Japan) comprising communication equipments.

In such a telecommunication telephone service, an on-line information service utilizing an Internet has recently been started. By the on-line information service, a user for portable telephone may transmit/receive an e-mail through a Web server of a carrier and access to home pages.

Because the image information provided from the Web server of carrier is pre-formed in a particular image format for a Web server of each carrier, a user to desire a provision of images should access to a Web server of a carrier providing a portable telephone service to acquire a necessary image into his/her portable telephone.

This means that a user could see only an image formed adapting to the type of a portable telephone used by a user and described by a language of dedicated format for a carrier providing a portable telephone service, and thus could not see an image of another carrier.

### DISCLOSURE OF THE INVENTION

An object of the present invention is to provide an image control system and method for allowing a user to freely access a Web server of a carrier other than the carrier providing a portable telephone service utilized by the user.

An image control system according to the present invention comprises a plurality of portable terminals each connected to an Internet through a communication network and having an image display function in a dedicated image display format; and a Web server for receiving an image information request, forming image information in a format allowing the portable terminal transmitting the request to be displayed, and transferring the formed image information to be a file format allowing the portable terminal transmitting the request to acquire the formed image information through the Internet and communication network.

### BRIEF DESCRIPTION OF DRAWINGS

FIG. 1 is a schematic diagram of an image control system of an embodiment according to the present invention.

FIG. 2 is an explanatory diagram for showing the relationship between a portable telephone and a Web server in FIG. 1.

FIG. 3 is an explanatory diagram for showing the layer structure of a software stored in a memory of the Web server in FIG. 1.

FIG. 4 is a flow of image processing steps in the image control system according to the present invention.

FIG. 5 shows a masking processing by a pallet, in which (a) shows an explanatory diagram for a composition by mask patterns, and (b) an explanatory diagram for jaggies in a composed pattern.

FIG. 6 is an explanatory diagram for a transmission image formed by using the mask pattern in FIG. 5.

FIG. 7 shows a memory of the Web server in which the image forming module to prepare a home page by a portable telephone.

FIG. 8 shows an example of the constitution of various tables, in which (a) shows an explanatory diagram for a layout table, (b) an explanatory diagram for a material managing table, and (c) an explanatory diagram for a determining table for the type of a portable telephone.

FIG. 9 shows a flow chart for representing the image forming by the image forming module.

### BEST MODE FOR CARRYING OUT THE INVENTION

A preferred embodiment will now be described with reference to the drawings.

Referring to 1, there is shown a schematic diagram of an image control system of an embodiment according to the present invention. As image control system 10 comprises a plurality of portable telephones 11a and 11b each having an image display function in a different display format, and a Web server 12 for transmitting the image information D to each of portable telephone 11a and 11b. As a portable terminal, there is a PDA (Personal Digital Assistant) other than a portable telephone.

The Web server 12 comprises an image forming module 13 for implementing a format mutual conversion processing among various image display formats. The image forming module 13 implements image processing steps such as an image superimpose processing including a filtering processing and transmission processing based on an image material M, an image extension/reduction processing, an image positioning processing, and so on.

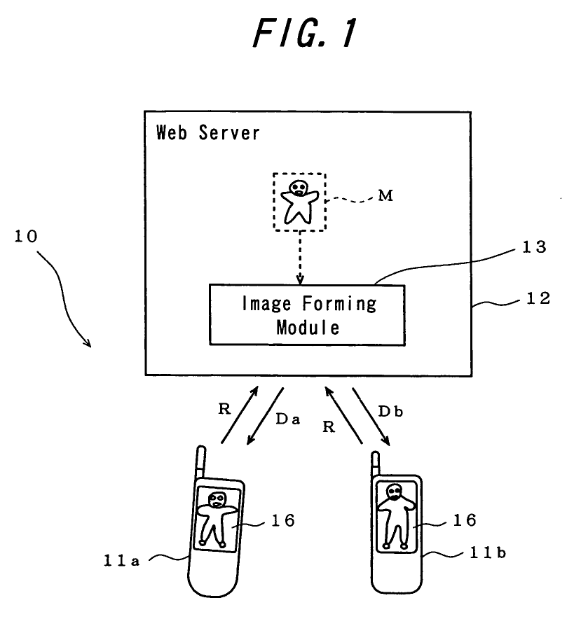

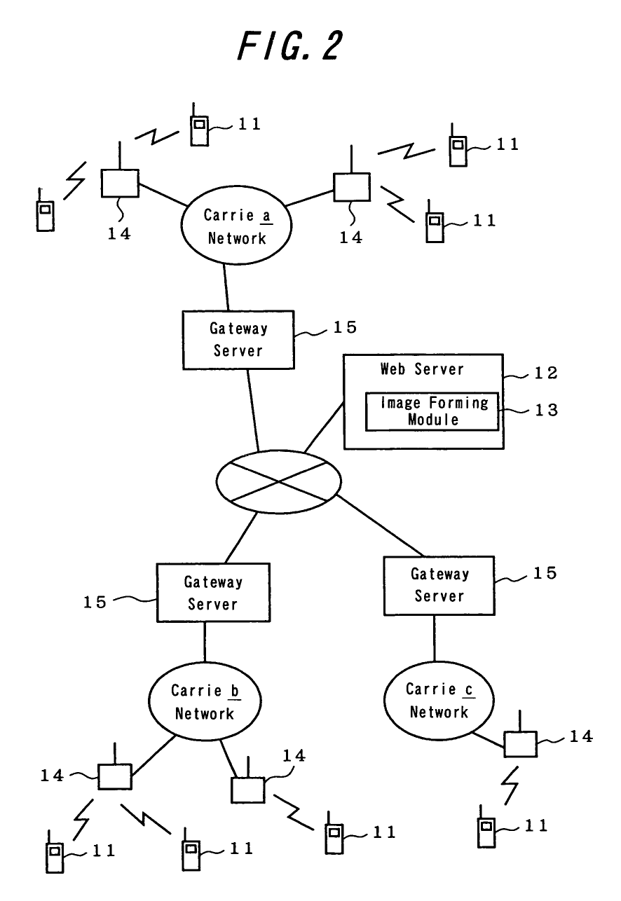

Referring to FIG. 2, there is shown an explanatory diagram for showing the relationship between a portable telephone and a Web server in FIG. 1. As shown in FIG. 2, a portable telephone 11 (11a and 11b) is connected to a communication network of a telecommunication company (i.e., a carrier) comprising telecommunication equipments through a base station 14. The communication network of each carrier (i.e., the communication network of a carrier a, the communication network of a carrier b and . . . ) is connected to an Internet through a gateway server 15. The Web server 12 is connected to the Internet.

Therefore, a user of the portable telephone may transmit an e-mail and access a dedicated home page through an on-line information service utilizing an Internet (e.g., i-mode (a registered trade mark) of Kabusiki Kaisha NTT DoCoMo), in addition to an interactive communication among the portable telephones 11, as a portable telephone service provided by the carrier. That is, the user of the portable telephone 11 may access the Web server 12 through the Internet.

In the image control system 10, when the portable telephone 11a utilizing a portable telephone service provided by the communication network of the carrier a transmits an image information request R to the Web server 12, for example, the image forming module 13 forms the image information Da in a display format which may be displayed on a display panel 16 of the portable telephone 11a transmitting the request, and the image information Da is acquired into the portable telephone 11a (see FIG. 1) through the communication network of the carrier (see FIG. 2)

This is the same as in the communication network of another carrier. When the portable telephone 11b utilizing a portable telephone server provided by the communication network of the carrier b transmits an image information request R to the Web server 12, the image forming module 13 forms the image information Db in a display format which may be displayed on a display panel 16 of the portable telephone 11b transmitting the request, and the image information Db is acquired into the portable telephone 11b (see FIG. 1) through the communication network of the carrier (see FIG. 2)

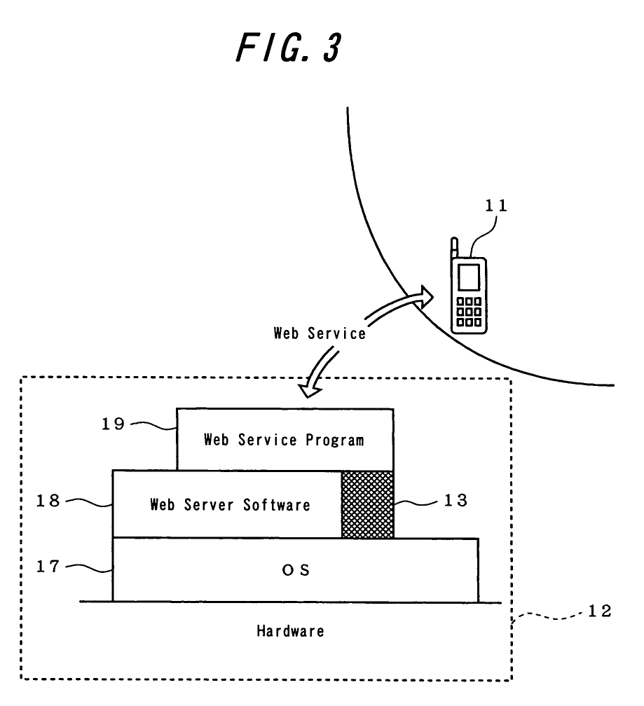

Referring to FIG. 3, there is shown an explanatory diagram for showing the layer structure of a software stored in a memory of the Web server in FIG. 1. As shown in FIG. 3, a Web server software 18 to be run on an operating system (OS) 17, a Web service program 19 to be run on the Web server software 18, and the image forming module 13 are stored in the memory of the Web server 12. The image forming module 13 is run on the operating system 17 together with the Web server software 18, and the processing for the image information of the Web service program 19 providing various sets of information accompanying images to the portable telephone 11 is run on the operating system 17 without being through the Web server software 18.

The image forming module 13 is provided as described above, so that the image information within various sets of information accompanying images provided by the Web service program 19 may directly utilize the function of the operating system 17 (i.e., the services provided by the operating system 17) through the image forming module 13. As a result, the processing equivalent to the application software may be provided as a Web service.

When the request for image information is transmitted from a user of the portable telephone 11, the Web service program 19 is run on the operating system through the image forming module 13, so that the image requested is formed in the image forming module 13.

The image forming module 13 is constituted by using COM (Component Object Model) which is a generalized expansion scheme for Windows (a registered trade mark of Microsoft), and implements a format mutual conversion processing among various image display formats for the image information, such as BMP (Bitmap), JPEG (Joint Photographic Experts Group), PNG (Portable Network Graphics), GIF (Graphic Interchange Format). Various image processings based on the request from the portable telephone 11 are carried out, the various image processings being an image superimpose processing including a filtering masking processing and transmission processing based on an image material M (a plurality of images are superimposed into one image), an image extension/reduction processing, an image positioning processing, and so on.

The Web server software 18 does not originally comprises the image forming function, and is required for processing the Web service program 19 of the application service provider (ASP) on the Web. Therefore, the format mutual conversion processing and various image processings are carried out without the limitation due to the Web server software 18 by processing only the image information of the Web service program 19 by means of the image forming module 13, whereas the portion to which the processing on the Web is required is processed on the Web server software 18.

Because the image processing and the display format conversion are required to directly operate the operating system 17, the Web service program 19 is directly bridged to the operating system 17 without being through the Web server software 18 such as IIS (Internet Information Services).

Therefore, when the image information in various sets of information provided as a Web service by an internet through a Web service program 19 is accessed from the portable telephone 11 to acquire the image information thereinto, the image information is automatically formed in a display format necessary for displaying the required image on the display panel 16, and the formed image information is transferred to a file format which allows the portable telephone 11 transmitting the request to acquire the formed image information through the internet and the communication networks. Finally, the formed image information is acquired into the portable telephone 11 to display on the display panel 16.

In the past, in order to provide an image information by a Web service program, the images which were pre-formed so as to be adapted to the format of each carrier were stored in a hard disk in the Web server, because the Web server software did not have a function of image formation. Therefore, when the request for acquiring an image was transmitted from a portable telephone, the image adapted to the format of the carrier relating to the portable telephone transmitting the request was selected from the pre-formed images and was sent.

Returning to FIG. 3, the image forming module 13 is operated on the operating system 17 during the processing by the module 13 in order to control the hard disk which is a memory of the Web sever 12 and secure a memory area for working.

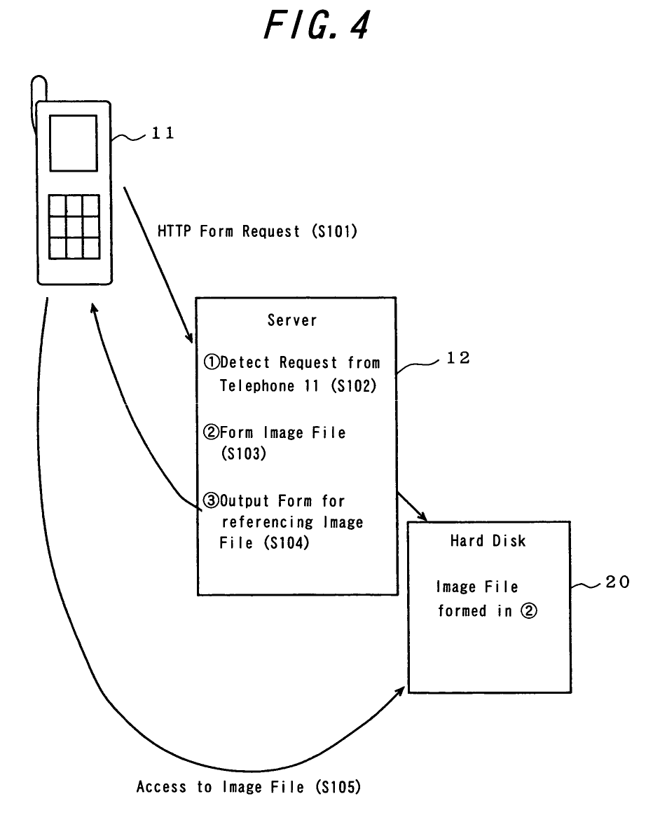

Referring to FIG. 4, there is shown a flow of the image processing in the image control system according to the present invention. As shown in FIG. 4, the portable telephone 11 accesses to the Web server 12 and requests a Web information in the form of HTTP (Hyper Text Transfer Protocol) (Step S101). When the Web server 12 detects the request from the portable telephone 11 or the user (Step S102), the Web server 12 determines the type of the portable telephone 11 and the carrier providing a portable telephone service. Next, the necessary functions for displaying an image supported by the determined type of a portable telephone (corresponding a image format, a liquid crystal display panel size and the like) are identified, and then the image file corresponding the function is formed to output it as a temporary file (Step S103). Therefore, the image which may be displayed in the display panel 16 of any type of portable telephone 11 may be formed. The formed image file is stored in the hard disk 20. After forming the image file, the form for referencing the image file is output from the Web server 12 to the portable telephone 11 (Step S 104).

After that, the portable telephone 11 accesses the image file of the hard disk 20 based on the form referencing the image file to acquire the image file thereinto. (Step S105.)

The Web information including the image file is described in HTML (Hyper Text Markup Language). An original HTML is used for each carrier, e.g., “HTML Version 5.0 for I-mode” for i-mode (Registered trade mark) of Kabushiki Kaisha NTT DoCoMo, “HTML Version 1.0.7 for J-sky” for J-sky of Kabushiki Kaisha Boda fone, and “WAP (Wireless Application Protocol) 2.0, HDML (Handheld Device Markup Language) 2.5” for EZ Web provided by Kabushiki Kaisha KDDI.

While the image processing is carried out by a filtering processing such as an anti-aliasing, the image processing for an image material M includes “extension and reduction”, “left/right-reversion and up/down-reversion”, “rotation”, “hue conversion”, “lightness conversion”, “γ-compensation”, “two-gradation (monochrome)”, “differentiation (border line extraction)”, “integration (shading off)”, “masking composition”, “aspect ratio conversion”, and “image composition”. The image composition includes “masking composition”, “transmission composition”, and “lightness composition (Only lightnesses are composed, which looks like a picture printed on an irregular paper.)

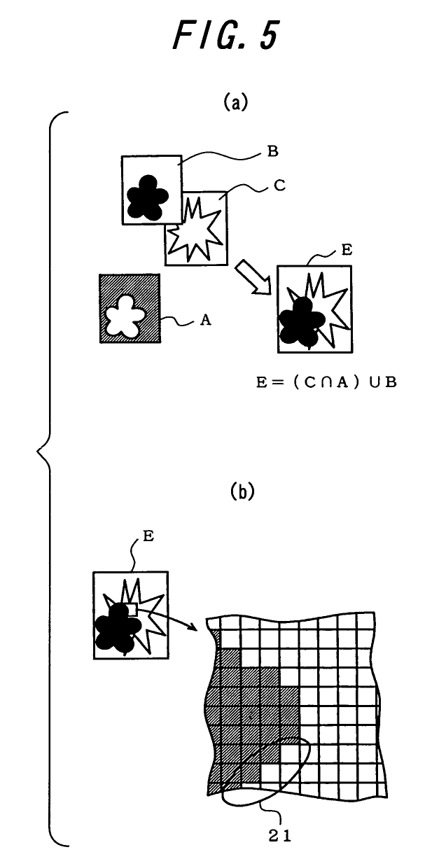

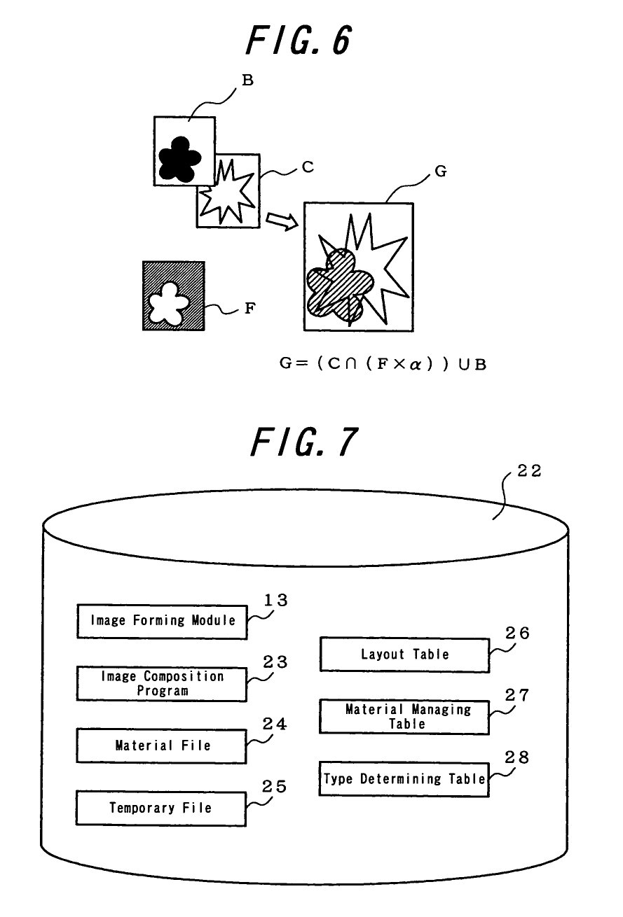

Referring to FIG. 5, there is shown a masking processing by a pallet, i.e., an image processing by the image forming module. In the figure, (a) shows an explanatory diagram for a composition by mask patterns, and (b) an explanatory diagram for jaggies in a composed pattern. Referring to FIG. 6, there is shown an explanatory diagram for a transmission image formed by using the mask pattern in FIG. 5.

As shown in FIG. 5, for the case of masking processing by pallets, a mask pattern A necessary for superimposing a plurality of images is formed in one color by using a foreground pattern B. The mask pattern A in two-gradation and the background pattern C are ANDed, subsequently ORed with the foreground pattern B to form the composed pattern E (E=(C n A) U B) (see FIG. 5(a)). In this case, jaggies 21 are generated in the border line between the foreground pattern B and background pattern C (see FIG. 5(b)).

In order not to generate jaggies 21 in the border line, the gradation (lightness in color) information is caused to be included in the colored mask pattern A when it is formed. In this case, the intermediate color between the color of the foreground pattern B and that of the background pattern C on the basis of the ratio between the gradations of the patterns B and C is used. In this manner, it is possible that jaggies 21 are not generated during the superimposition of images.

If the gradation of 50% is provided to the mask pattern A to form the mask pattern F having a transmission factor (α), the composed pattern G (G=(C ∩(F×α)∪B) may be formed using the patterns F, B and C (see FIG. 6). The composed pattern G is a transmission image in which the background pattern C is seen through the foreground pattern B. It is to be noted that the transmission factor (α) is not limited to 50%, but may be varied if necessary.

As described above, the image forming module 13 may implement on real time an image processing such as a superimposition processing, a filtering processing, and the conversion of an image format for the portable telephone 11.

While an application software is an execution program format referred to as an EXE type, a script language is currently used for a program processing on a Web. However, there is no relationship between the execution EXE and the script language. In order to establish the relationship therebetween, an EXE program is transferred to a DLL (Dynamic Link Library) format so as to be read on a Web.

Utilizing an image processing by the image forming module 13, a home page accessed by the portable telephone 11 may be prepared. One example of the home pages is an imaginative haunted house which is prepared by combining various image parts with a plurality kinds of background images based on user's taste.

Referring to FIG. 7, there is shown a memory of the Web server in which the image forming module to prepare a home page accessed by a portable telephone is stored. As shown in FIG. 7, a memory 22 of the Web server 12 stores an image composition program 23, a material file 24, a temporary file 25, a layout table 26, a material managing table 27, a determining table 28 for the type of a portable telephone, and the like. The memory 22 may be provided as an external storage means separating from the Web server 12, for example, and may be the hard disk 20 (see FIG. 4).

The Web server 12 comprises, other than the memory 22, a CPU (Central Processing Unit) for running the image composition program 23 to implement a processing necessary for an image composition, a RAM (Random Access Memory) for storing a data temporarily, an image processing means for generating a necessary image data based on indications from the CPU, and the like.

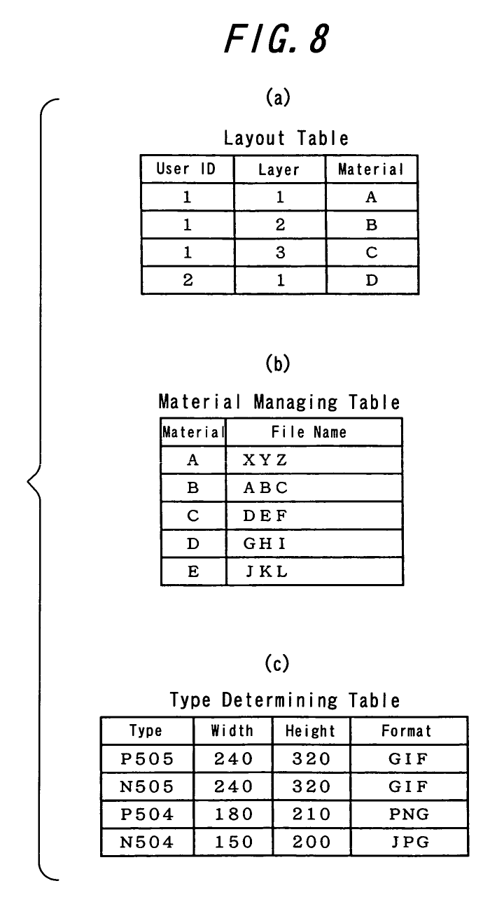

Referring to FIG. 8, there is shown an example of the constitution of various tables. In the figure, (a) shows an explanatory diagram for a layout table, (b) an explanatory diagram for a material managing table, and (c) an explanatory diagram for a determining table for the type of a portable telephone. As shown in FIG. 8, the layout table is a table representing the correspondence among a user ID (Identification), layers for distinguishing protocols, and image forming materials (see (a)), the material managing table is a table representing the correspondence between image forming materials and file names (see (b)), and the determining table for the type of a portable telephone is a table representing the correspondence among the type of a portable telephone 11, the size of a crystal display panel (width and height), and the image format (see (c)).

“A haunted house” dedicated for a user of the portable telephone 11 may be prepared according to user's taste by freely changing an image layout by means of the image forming module 13. In order that a user changes an image layout, the user accesses the home page of “a haunted house”, and then select a layout change menu to designate a changing matters. While changing the image layout, the user may select a setting location of “a haunted house” from a plurality of background images, and arrange any number of bogeies (characters) on the background image. The user, furthermore, may arbitrarily select the size and the arrangement location (vertical and lateral directions, and depth position in the display panel), and the transmission factor for superimposed images for one bogey.

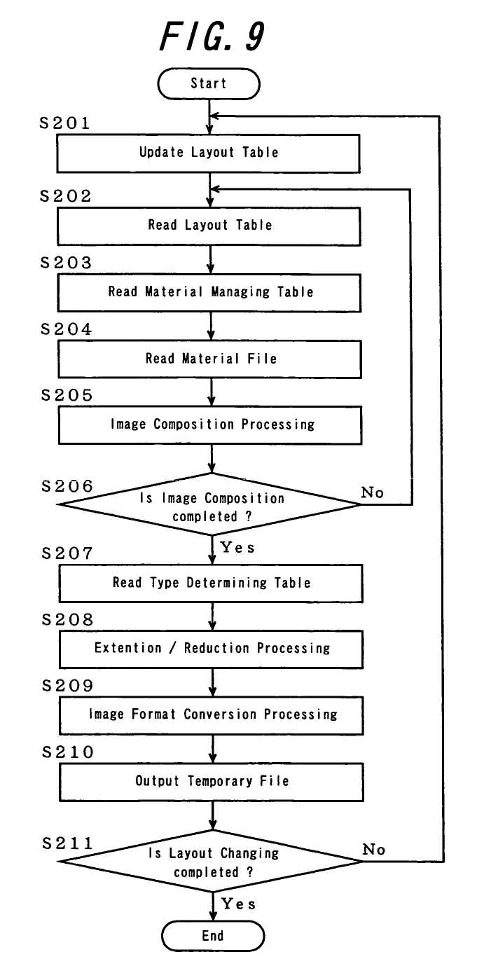

Referring to FIG. 9, there is shown a flow chart for representing the image formation by the image forming module. As shown in FIG. 9, the layout table 26 is updated based on a layout changing request from a user (Step S 201). Next, corresponding to the layout changing matters requested by the user, the layout table 26 is read (Step S202), the material managing table 27 is read (Step S203), the material file 24 is read (Step S 204), and finally the image composition processing is carried out (Step S205).

After the image composition processing, whether the composition of all layers is completed or not is determined (Step S206). If the composition of all layers is not completed (i.e., No), then go back to Step S202. Again, the layout table 26 is read, the material managing table 27 is read, the material file 24 is read, the image composition processing is carried out, and finally whether the composition of all layers is completed or not is determined. That is, the processings are repeated until the composition of all layer based on the layout changing request from the user is completed. As a result, the image forming module 13 is repeatedly is read out based on the image processing request to carry out the image composition process on the Web server 12.

If the composition of all layers is completed (i.e., Yes), then the determining table 28 for the type of a portable telephone is read (Step S207). By reading the table 28, the size of the display panel 16 of the portable telephone 11 for displaying the composited image is determined to carry out the necessary extension/reduction processing necessary for displaying the composited image (Step S208). After that, the image format conversion processing is carried out (Step S209) and the temporary file 25 is output (displayed) (Step S210).

After the temporary file 25 is output, whether the layout changing is completed or not is determined (Step S211). If the layout changing is not completed (i.e., No), then go back to S201. Again, the subsequent processings are carried out to determine whether the layout changing is completed or not. If the layout changing is completed (i.e., Yes), the process is terminated.

After the image forming processing by the image forming module 13, the formed image data is controlled by the image composition program 23 and is exposed to necessary processings based on the indication from the image composition program 23. The information processing due to these image forming module 13 and image composition program 23 is carried in the Web server 12 by cooperative operation of software and hardware.

In this manner, when the request for acquiring an image is provided from the portable telephone 11, the image control system 10 in the Web server 12 according to the present invention automatically processes image materials M to make the image based on the request and form the image file adapted to the format required to display the image on the display panel of the portable telephone 11 providing the request.

According to the image control system 10, the functions such as the changing of the size, position and density of the image which are not the functions of the portable telephone itself may be realized on the portable telephone 11, in spite that the portable telephone does not have the same function as in a personal computer.

In the image control system 10, because the image information may be variously processed and transmitted to the portable telephone 11 independently of the difference of the carriers each providing a communication network and the difference of the types of portable telephones, the image may be displayed on the display panel regardless of the type of a portable telephone. Therefore, both of text and image information may be transmitted together to the portable telephone 11 belonged to different carriers. As a result, a user of a portable telephone may freely access to the Web server of the other carriers other than the carrier from which the user utilized the portable telephone service to acquire the image provided by the other carriers. Therefore, the user may freely see the image provided the other carriers.

Until now, a provider for a Web site have made an image of Web information so as to be adapted to the type of a portable telephone 11 and the carrier thereof. Accordingly, the provider has identified the type of a portable telephone 11 which requests a provision of Web information, and has transmitted an image pre-formed so as to be dedicatedly adapted to each type of a portable telephone. On the contrary, the image control system 10 according to the present invention identifies the type of a portable telephone even if it has any type thereof, and then automatically form an image so as to be adapted to the identified type of a portable telephone, thereby it is unnecessary to form various kinds of images for each type of a portable telephone.

Because a Web application should have an interactive function with a portable telephone user, so that the images corresponding to all of requests should have been prepared in advance for the case that the image on the Web application has been changed based on the request from a portable telephone user. For example, when goods have been selected in a shopping site, the photographs of the selected goods should have been displayed.

Therefore, the number of images to be prepared has been exponentially increased as the number of the combinations of requests from the portable telephone users has become large. For example, when the image of the coordinates of clothes have intended to be displayed, the images of all the combinations of clothes to be selected in the shopping site should have been prepared in advance.

In order to realize this, a combination/composition processing for a large number of image materials should be immediately implemented after the request form a user. In such a case, the image control system according to the present invention may immediately and efficiently process the situation.

### INDUSTRIAL APPLICABILITY

According to the present invention, the image forming module may implement on real time an image processing such as a superimposition processing, a filtering processing, and the conversion of an image format for the portable telephone. Also, the image information may be transmitted to the portable telephone independently of the difference of the carriers. Therefore, both of text and image information may be transmitted together to the portable telephones belonged to different carriers. As a result, a user of a portable telephone may freely access to the Web server of the other carriers other than the carrier from which the user utilizes the portable telephone service to acquire the image provided by the other carriers.

1. An image control system, comprising:
a plurality of portable terminals each connected to an Internet through an communication network and having an image display function in a dedicated image display format; and
a Web server for receiving an image information request, forming image information in a format allowing the portable terminal transmitting the request to be displayed, and transferring the formed image information to be a file format allowing the portable terminal transmitting the request to acquire the formed image information through the Internet and communication network.

2. The image control system according to claim 1, wherein the Web server includes an image forming module for implementing a format mutual conversion processing among various image display format with respect to the image information.

3. The image control system according to claim 2, wherein the image forming module is operated on an operating system together with a Web server software, and implements a processing for image information of a Web service program to provide various information accompanying an image to the portable terminal without being through the Web server software.

4. The image control system according to claim 2 or 3, wherein the image forming module implements an image superimposition processing including a transmission processing, an image extension/reduction processing, and an image processing including at least an image arranging processing.

5. The image control system according to claim 4, wherein the transmission processing is implemented with a transmission factor being varied.

6. An image control method, comprising the steps of:
requesting image information by a plurality of portable terminals each connected to an Internet through a communication network and having an image display function in a dedicated image display format; and
forming image information in a format allowing the portable terminal transmitting the request to be displayed, and causing the formed image information to be a file format allowing the portable terminal transmitting the request to acquire the formed image information through the Internet and communication network, by a Web server for receiving the image information request.

7. The method according to claim 6, wherein a processing for image information of a Web service program to provide various information accompanying an image to the portable terminal including a format mutual conversion processing among various image display format with respect to the image information is implemented without being through the Web server software.

8. The method according to claim 7, wherein the processing for image information of the Web service program includes an image superimposition processing including a transmission processing, an image extension/reduction processing, and an image processing including at least an image arranging processing.

9. The method according to claim 8, wherein the image processing is implemented by a loop repeat processing based on an image processing request.
